(19) United States
(12) Patent Application Publication
(10) Pub. No.: US 2026/0052481 A1
(43) Pub. Date: Feb. 19, 2026

(54) READER DEVICE SELECTION FOR AMBIENT INTERNET OF THINGS (AIOT) DEVICE POSITIONING

(71) Applicant: Lenovo (Singapore) Pte Limited, Singapore (SG)

(72) Inventors: Hyung-Nam CHOI, Ottobrunn (DE); Robin Rajan THOMAS, Bad Nauheim (DE); Karthikeyan GANESAN, Nauheim (DE); Ali Ramadan ALI, Kraiburg am Inn (DE)

(21) Appl. No.: 18/807,598

(22) Filed: Aug. 16, 2024

(51) Int. Cl. H04W 52/02; H04W 4/02; H04W 4/80

(52) U.S. Cl. CPC H04W 52/0245; H04W 4/023; H04W 4/80

(57) ABSTRACT

Various aspects of the present disclosure relate to selection of reader devices for positioning of ambient Internet of Things (AIoT) devices. For example, the present disclosure introduces messaging between a network, reader devices, and AIoT devices that provides for the discovery and selection of reader devices appropriate for AIoT devices within a certain location (e.g., a target area) such as an indoor facility.

### TECHNICAL FIELD

The present disclosure relates to wireless communications, and more specifically to reader device selection for ambient Internet of Things (AIoT) device positioning.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Ambient power-enabled devices, such as Internet of Things (IoT) devices, or AIoT devices, include battery-less devices that have limited storage capabilities (e.g., they store a limited amount of energy using capacitors) or other capability restrictions. These restricted devices may store energy by harvesting energy from the environment of the IoT device, such as via radio waves, light, heat, motion, and other energy/power sources available to the IoT device.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that facilitate the selection of reader devices for positioning of ambient-powered IoT devices.

Some implementations of the method and apparatuses described herein may further include a reader device for wireless communication, comprising at least one memory, and at least one processor coupled with the at least one memory and configured to cause the reader device to transmit, to an IoT device, a first message that comprises a proximity request, receive, from the IoT device, a second message that comprises a proximity response, and determine the proximity of the reader device to the IoT device based on the second message.

In some implementations of the method and apparatuses described herein, the at least one processor is further configured to cause the reader device to receive a third message from a core network node that comprises one or more criteria to determine the proximity of the reader device to the IoT device and transmit a fourth message that indicates the determined proximity to the core network node.

In some implementations of the method and apparatuses described herein, the one or more criteria comprises a distance threshold value between the reader device and the IoT device.

In some implementations of the method and apparatuses described herein, the first message comprises identity information for the IoT device.

In some implementations of the method and apparatuses described herein, to determine the proximity of the reader device to the IoT device, the at least one processor is further configured to cause the reader device to measure a received signal strength indicator (RSSI) associated with the second message and determine a distance between the reader device and the IoT device based on the measured RSSI.

In some implementations of the method and apparatuses described herein, the at least one processor is further configured to cause the reader device to determine that the proximity of the reader device satisfies one or more criteria.

In some implementations of the method and apparatuses described herein, the at least one processor is further configured to cause the reader device to transmit a message that indicates the determined proximity to a network entity in response to the one or more criteria being satisfied.

In some implementations of the method and apparatuses described herein, the reader device is a UE.

In some implementations of the method and apparatuses described herein, the reader device is a network entity.

In some implementations of the method and apparatuses described herein, the IoT device is an ultra-low complexity device with ultra-low power consumption.

Some implementations of the method and apparatuses described herein may further include a core network node for wireless communication, comprising at least one memory and at least one processor coupled with the at least one memory and configured to cause the core network node to transmit, to a reader device, a first message that comprises one or more criteria for determining a proximity of the reader device to an IoT device, and receive, from the reader device, a second message that identifies the proximity of the reader device to the IoT device.

In some implementations of the method and apparatuses described herein, the at least one processor is further configured to receive, from an IoT server, a request message that comprises an identifier for the IoT device and the one or more criteria for determining the proximity of the reader device to the IoT device and determine a set of candidate reader devices that includes the reader device based on the request message.

In some implementations of the method and apparatuses described herein, the second message comprises an identifier for the reader device and information that indicates a distance between the IoT device and the reader device, and wherein the at least one processor is further configured to cause the core network node to select the reader device based on the information that indicates the distance between the IoT device and the reader device and store information associated with the selected reader device to a unified data repository that relates the IoT device to reader devices selected for the IoT device.

In some implementations of the method and apparatuses described herein, the at least one processor is further configured to cause the core network node to receive, from an IoT server, a request message that comprises positioning service requirements for IoT devices and configure a distance threshold value as a criterion of the one or more criteria based on the positioning service requirements.

In some implementations of the method and apparatuses described herein, the at least one processor is further configured to cause the core network node to select the reader device to perform a positioning procedure with the IoT device.

In some implementations of the method and apparatuses described herein, the reader device is a UE, the at least one processor is further configured to cause the core network node to transmit, to a network entity that serves the reader device, a request message that comprises a request for IoT device reader functionality and positioning capability information for the reader device, receive, from the network entity, a response message that comprises the requested IoT device reader functionality and positioning capability information, and select the reader device to perform a positioning procedure with the IoT device based on the IoT device reader functionality and positioning capability information.

Some implementations of the method and apparatuses described herein may further include a processor for wireless communication, comprising at least one controller coupled with the at least one memory and configured to cause the processor to transmit, to an IoT device, a first message that comprises a proximity request, receive, from the IoT device, a second message that comprises a proximity response, and determine the proximity of the processor to the IoT device based on the second message.

In some implementations of the method and apparatuses described herein, the at least one controller is further configured to cause the processor to receive a third message from a core network node that comprises one or more criteria to determine the proximity of the processor to the IoT device and transmit a fourth message that indicates the determined proximity to the core network node.

In some implementations of the method and apparatuses described herein, to determine the proximity of the reader device to the IoT device, the at least one controller is further configured to cause the processor to measure an RSSI associated with the first message and determine a distance between the processor and the IoT device based on the measured RSSI.

Some implementations of the method and apparatuses described herein may further include a method performed by a communication device, the method comprising transmitting, to an IoT device, a first message that comprises a proximity request, receiving, from the IoT device, a second message that comprises a proximity response, and determining the proximity of the communication device to the IoT device based on the second message.

### BRIEF DESCRIPTION OF THE DRAWINGS

FIG. 1 illustrates an example of a wireless communications system in accordance with aspects of the present disclosure.

FIG. 2 illustrates an example topology of an AIoT device and reader device in accordance with aspects of the present disclosure.

FIG. 3 illustrates an example diagram depicting AIoT device positioning in accordance with aspects of the present disclosure.

FIG. 4 illustrates an example diagram of a messaging flow between devices for AIoT device positioning in accordance with aspects of the present disclosure.

FIG. 5 illustrates an example diagram of a messaging flow for exchanging capability information between devices in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE or NE in accordance with aspects of the present disclosure.

FIG. 10 illustrates a flowchart of a method performed by an NE in accordance with aspects of the present disclosure.

### DETAILED DESCRIPTION

A wireless communication system may include one or more AIoT devices, which may be a passive-IoT device or a passive radio frequency identification (RFID) tag (e.g., sticker, tag, badge, patch, or the like) that supports one or more functionalities at lower cost and maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device). The AIoT may perform one or more operations (e.g., transmission, reception, via backscattering) using the stored harvested energy. For example, the AIoT device may be a passive RFID tag equipped on an object or other device enabling for tracking of a location of the object or the other device using stored harvested energy.

An AIoT device may be classified according to one or more categories. A first category AIoT device may lack both energy harvesting capabilities and communication capabilities. As such, the first category AIoT device may be considered a passive device and be exclusively capable of performing backscattering operations (e.g., backscattering transmissions). A second category AIoT device may support energy harvesting capabilities but lack communication capabilities. As such, the second category AIoT device may be considered a semi-passive device and be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may be considered an active device and support both energy harvesting and communication capabilities. In this example, the third category AIoT device may be equipped with an active radio frequency circuitry to support active communication (e.g., transmission, reception of signals).

In some cases, the wireless communications system may implement various topologies and deployment scenarios, such as one example topology in which an NE (e.g., a base station or other network entity) functions as a reader device and a source of a carrier wave (e.g., for exciting an AIoT device to perform backscattering), another example topology where the UE functions as the reader device and the source of the carrier wave, another example topology in which the NE functions as the reader device and a different device (e.g., a UE or other intermediate node) functions as the source of the carrier wave (e.g., an emitter node), another example topology in which the NE controls operations and other network entities (e.g., nodes) function as reader devices and/or carrier wave sources, and so on.

In some cases, a deployment scenario may include an indoor inventory, where multiple AIoT devices are located within an indoor facility (e.g., a warehouse, factory, mall, airport, and so on). The positioning of the AIoT devices is performed by one or more reader devices (e.g., UEs and/or BSs) deployed throughout the indoor location. For example, the AIoT devices may be positioned at different locations, leading to different relative distances, with the reader devices.

Thus, some reader devices, such as those located within a threshold maximum distance (e.g., less than 10-50 meters), may be appropriate to select for positioning for a given AIoT device or devices. Otherwise, the selection of reader devices that do not meet certain distance threshold may not satisfy positioning requirements and/or may fail to accurately read or otherwise perform requested operations with associated AIoT devices, among other drawbacks.

The present disclosure introduces a framework for messaging between a network, reader devices, and AIoT devices that provides for the discovery and selection of reader devices appropriate for AIoT devices within a certain location (e.g., a target area). For example, the present disclosure enables the messaging for proximity detection of reader devices, reader device selection, and reader device capabilities.

The utilization of such messaging facilitates a network or requesting entity (e.g., an AIoT server associated with AIoT devices deployed at a location) to select reader devices that are appropriate for their AIoT devices. In doing so, the messaging enables an efficient and reliable deployment and operation of multiple AIoT devices at a location, among other benefits.

Aspects of the present disclosure are described in the context of a wireless communications system.

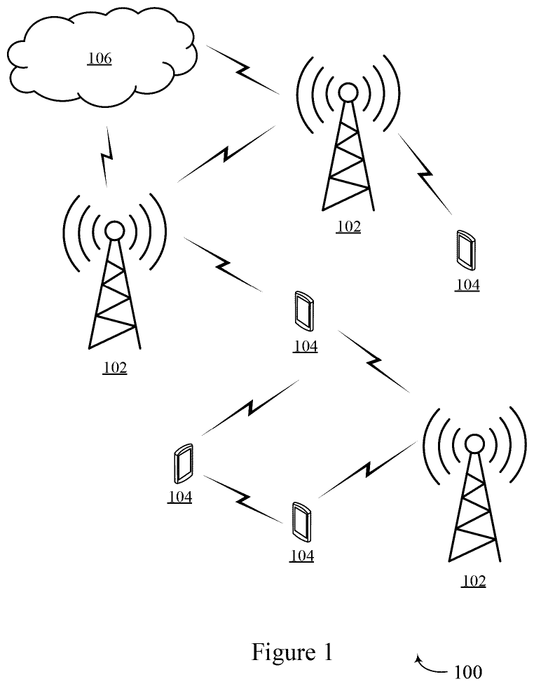

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be an example of the UE 104), such as ambient IoT devices. As described herein, an AIoT device may be associated with a low complexity profile (e.g., low power consumption, less capabilities).

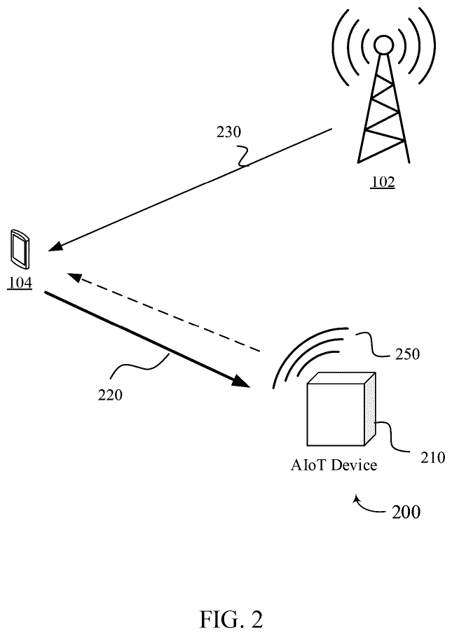

FIG. 2 illustrates an example topology 200 of an AIoT device and reader device in accordance with aspects of the present disclosure. The topology 200 includes the NE 102 (e.g., a base station), the UE 104 (e.g., acting as an emitter node and reader node), and an AIoT device 210. The UE 104, in response to instructions 230 from the NE 102, sends carrier waves 220 to the AIoT device 210. The carrier waves 220 excite the AIoT device 210, enabling or causing the AIoT device 210 to performing backscattering transmissions 250, which are read by the UE 104 (acting as a reader device, or reader).

While the topology 200 illustrates one deployment of the AIoT device 210, other deployments are possible. For example, a deployment may include the NE 102 acting as the emitter node and the reader (or receiver) node, a deployment may include the UE 104 as the emitter node and the reader (or receiver) node, a deployment may include another NE 102 as an intermediate node (e.g., an emitter node), and so on.

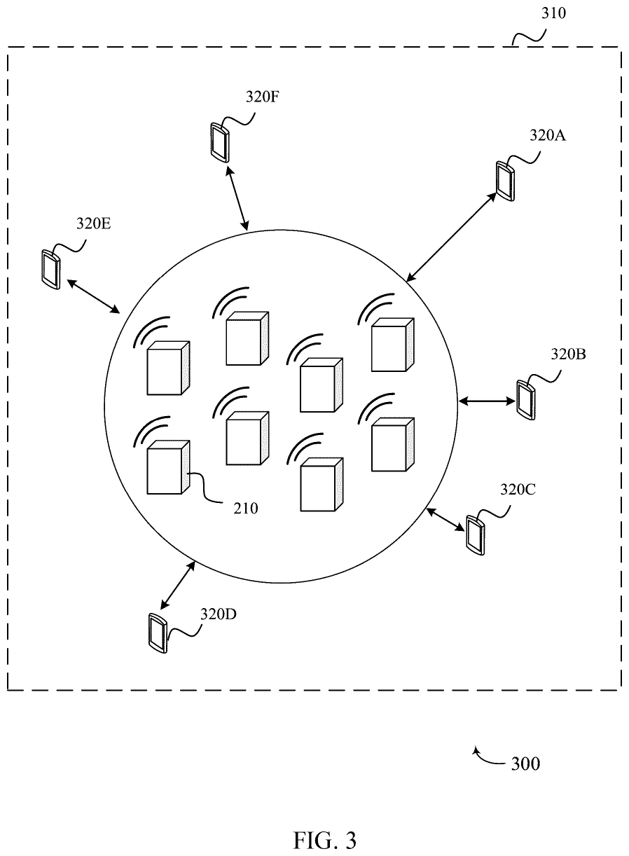

FIG. 3 illustrates an example diagram 300 depicting AIoT device positioning in accordance with aspects of the present disclosure. A location 300, or target area (e.g., a warehouse or other indoor facility), includes multiple reader devices 320A-F deployed and/or positioned with respect to various AIoT devices 210. The reader devices 320A-F may include stationary reader devices (e.g., devices fixed or installed to one location within the location 310), mobile reader devices (e.g., devices that move within the location 310), and so on. As shown, there is a distance, which may vary, between each of the reader devices 320A-F and the AIoT devices 210.

As described herein, a network may utilize various messaging flows when determining positioning for AIoT devices with respect to different reader devices. For example, when determining whether reader devices are near a certain (or target) AIoT device, a CN (e.g., the CN 106) associated with the AIoT devices 210, such as an AMF with AIoT functionality, may initiate a proximity determination procedure for the target AIoT device and candidate reader devices in a location.

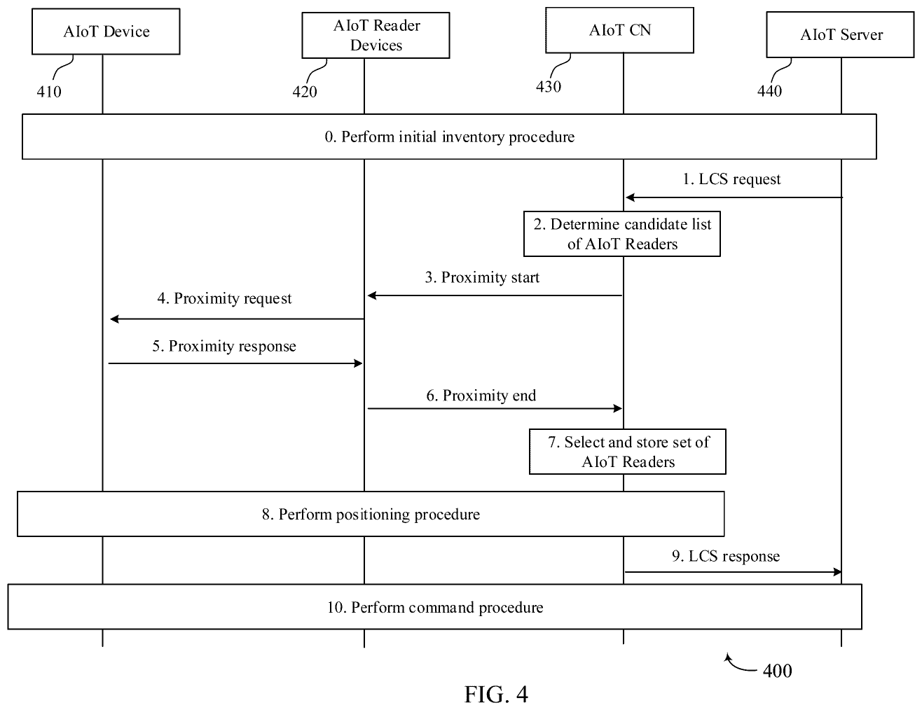

FIG. 4 illustrates an example diagram of a messaging flow 400 between devices for AIoT device positioning in accordance with aspects of the present disclosure. The messaging flow 400 may implement various aspects of the present disclosure described herein. For example, the messaging flow 400 may include an AIoT device 410, multiple AIoT reader devices 420, an AIoT CN 430, and an AIoT server 440, which may be examples of AIoT devices, reader devices, CN nodes, and servers, as described herein. In the following description of the messaging flow 400, the operations between the AIoT device 410, multiple AIoT reader devices 420, the AIoT CN 430, and the AIoT server 440 may be performed in different orders or at different times. Some operations may also be omitted, or other operations may be added. Although the AIoT device 410, multiple AIoT reader devices 420, an AIoT CN 430, and an AIoT server 440 are shown performing the operations of the messaging flow 400, some aspects of some operations may also be performed by other entities of the messaging flow 400 or by entities that are not shown in the messaging flow 400, or any combination thereof.

In step 0, an initial inventory procedure is performed, including the AIoT server 440, the AIoT CN 430, a stationary AIoT reader device of the multiple AIoT reader devices 420, and the AIoT device 410. As a result of the initial inventory procedure, the identity of an object (e.g., an electronic product code (EPC) on an RFID tag) associated with the AIoT device 410 and a physical location (e.g., an area within a warehouse and/or an area served by a specific BS) of the AIoT device 410 is determined. During the initial inventory procedure, the AIoT CN 430 identifies all of the AIoT reader devices 420, using the stationary reader device to perform an inventory of the location, and stores the information regarding the identities of the AIoT reader devices 420.

In step 1, the AIoT server 440 transmits a location service (LCS) request message to request the AIoT CN 430 to determine a (more) precise location of the AIoT device 410 in the target area. The LCS request message contains an identity of the AIoT device 410 and a requested accuracy requirement for positioning the AIoT device 410 with respect to a reader device (e.g., a value of three meters, or less). In some cases, the LCS request message may contain a list of AIoT positioning quality of service (QoS) parameters, such as the requested accuracy requirement, a requested response time (e.g., a value of one second), a velocity request for moving/mobile AIoT devices, and so on.

In step 2, in response to receiving the LCS request message, the AIoT CN 430 determines a set of candidate AIoT reader devices, from the multiple AIoT reader devices 420, for positioning the AIoT device 410. For example, the AIoT CN 430 may determine a set of the multiple AIoT reader devices 420, such as reader devices 320A-F, as candidates based on AIoT reader device information stored by the AIoT CN 430.

In step 3, the AIoT CN 430 transmits to each candidate reader device (e.g., reader devices 320A-F) a proximity start message that contains an identifier for the AIoT device 410 and criteria for proximity determination (e.g., a distance threshold value set to 3 m or fewer based on a measurement of RSSI).

In step 4, in response to receiving the proximity start message, each of the multiple AIoT reader devices 420 (e.g., reader devices 320A-F) transmits a proximity request message to the AIoT device 410 that contains the ID for the AIoT device 410.

In step 5, the AIoT device 410 receives the proximity request message from each of the multiple AIoT reader devices 420 and transmits back a proximity response message that contains its ID. For example, the AIoT device 410 receives the proximity request message from reader device 320A, reader device 320B, reader device 320C, reader device 320D, reader device 320E, and reader device 320F, and transmits the proximity response message back to reader device 320A, reader device 320B, reader device 320C, reader device 320D, reader device 320E, and reader device 320F.

In step 6, each of the multiple AIoT reader devices 420 receives the proximity response message from the AIoT device 410 and determines a distance to the AIoT device 410 by measuring the RSSI of the proximity response message. When the distance, determined using the measured RSSI, is lower or equal to a distance threshold value (e.g., a threshold value set to 3 m) the AIoT reader device transmits a proximity end message to the AIoT CN 430 that contains the ID of the AIoT device 410 and the determined distance between the AIoT reader device and the AIoT device 410.

For example, if only reader devices 320B, 320C, 320E, and 320F are within three meters of the AIoT device 410, then only those AIoT reader devices transmit the proximity end message to the AIoT CN 430. The other AIoT reader devices (e.g., reader devices 320A and 320D) may transmit a proximity failure message or other messaging that indicates a failure to determine a proximity to the AIoT device 410 and/or an indication that the distance to the AIoT device 410 is greater than the threshold value.

In step 7, the AIoT CN 430 selects the AIoT reader devices that transmitted the proximity end message for positioning of the AIoT device 410. The AIoT CN 430 may store information relating the selected AIoT reader devices to the AIoT device 410 into a unified data repository (UDR) or other data store associated with the AIoT CN 430. For example, each entry relating an AIoT reader device to the AIoT device 410 may include an identifier for the AIoT reader device, an identifier for the AIoT device 410, the determined distance between the devices, and so on.

In step 8, for each of the selected AIoT reader devices, the AIoT CN 430 initiates a positioning procedure towards the AIoT device 410. For example, in accordance with AIoT positioning capabilities of the selected AIoT reader devices and the AIoT device 410, the AIoT CN 430 configures a positioning mode and/or positioning method for the selected AIoT reader devices and the AIoT device 410. The selected AIoT reader devices may perform the positioning procedure to determine and transmit the location of the AIoT device 410 to the AIoT CN 430.

In step 9, the AIoT CN 430 transmits to the AIoT server 440 an LCS response message that contains the determined location of the AIoT device 410.

In step 10, upon receiving the determined location of the AIoT device 410, the AIoT server 440 may initiate a command procedure towards the AIoT device 410, such as a procedure to read data captured by and stored in the AIoT device 410. The AIoT CN 430 may select an appropriate AIoT reader device from the selected AIoT reader devices, such as an AIoT reader device that is closest to the AIoT device 410. In some cases, the AIoT CN 430 may initiate a new or subsequent proximity determination procedure for the selected AIoT reader devices prior to initiating the command procedure.

In some cases, the AIoT CN 430 may select an appropriate AIoT reader device in accordance with requested AIoT positioning service requirements and distance threshold values. For example, in cases of best-effort accuracy requirements, the AIoT CN 430 may select AIoT reader devices having a proximity to the AIoT device 410 that are within a first distance threshold value distance (e.g., a distance1 of 10 m). As another example, to determine a more accurate location of AIoT reader devices, the AIoT CN 430 may select AIoT reader devices having a proximity to the AIoT device 410 that is within a second distance threshold value (e.g., a distance2 of 1 m).

Thus, an AIoT server (e.g., the AIoT server 440), via a network node (e.g., the AIoT CN 430) may find and/or select appropriate reader devices for the positioning of a target AIoT device, enhancing associated inventory procedures and command procedures, among other benefits.

In some embodiments, the AIoT CN 430 may determine the capabilities and locations of candidate AIoT reader devices, implemented as UEs, that are registered within a location. The AIoT CN 430 may determine capabilities/locations of candidate AIoT reader devices during an initial inventory procedure, such as during step 0 of the messaging flow depicted in FIG. 4.

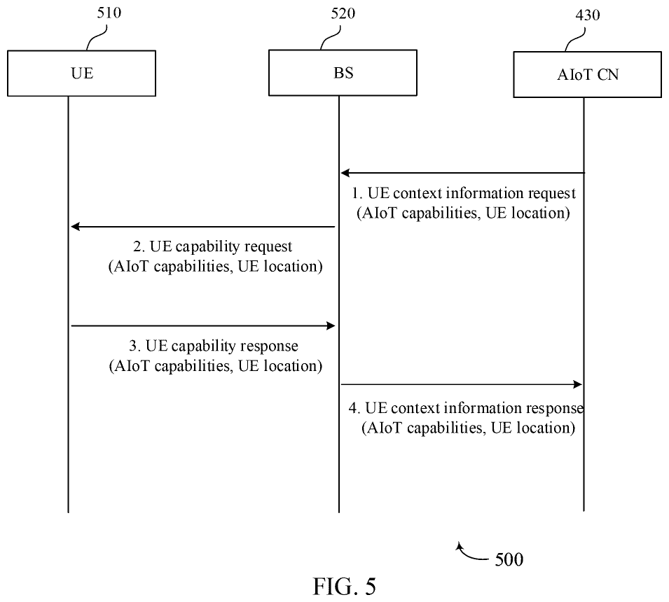

FIG. 5 illustrates an example diagram of a messaging flow 500 for exchanging capability information between devices in accordance with aspects of the present disclosure. The messaging flow 500 may implement various aspects of the present disclosure described herein. For example, the messaging flow 500 may include a UE 510, a BS 520, and the AIoT CN 430, which may be examples of UEs, BSs, AIoT devices, reader devices, and CN nodes, as described herein. In the following description of the messaging flow 500, the operations between the UE 510, the BS 520, and the AIoT CN 430 may be performed in different orders or at different times. Some operations may also be omitted, or other operations may be added. Although the UE 510, the BS 520, and the AIoT CN 430 are shown performing the operations of the messaging flow 500, some aspects of some operations may also be performed by other entities of the messaging flow 500 or by entities that are not shown in the messaging flow 500, or any combination thereof.

In step 1, the AIoT CN 430 sends a UE context information request message to the BS 520 to request the AIoT capabilities (e.g., AIoT reader functionality and AIoT positioning functionality for the UE) and location of the UE 510 (e.g., an intermediate UE) served by the BS 520.

In step 2, upon receiving the UE context information request message, the BS 520 transmits a UE capability enquiry message (e.g., a request message) to the UE 510 to request its AIoT capabilities and location information. The BS 520 may transmit the request message via various messaging protocols, such as radio resource control (RRC) signaling RRC over the Uu interface.

In step 3, upon receiving the UE capability enquiry message, the UE 510 transmits a UE capability information message, which includes the requested AIoT capabilities and location information to the BS 520. The UE capability information may include and/or indicate (1) an AIoT reader capability of the UE 510, such as its functionality to support communications to one or multiple AIoT devices over an AIoT air interface for inventory/command procedures, and/or (2) the AIoT positioning capability of the UE 510, such as the supported positioning modes (e.g. UE-based, UE-assisted, BS-based, BS-assisted) and positioning methods (e.g. uplink time difference of arrival (UL-TDoA) and/or uplink angle of arrival (UL-AoA)) performed by the UE 510.

In step 4, the BS 520 transmits the AIoT capabilities and location information received from the UE 510 to the AIoT CN 430 via a UE context information response message. In some cases, the AIoT CN 430 stores the AIoT capabilities and location information received from the UE 510 as part of context information for a specific AIoT device in the UDR. Furthermore, in some cases, the AIoT CN 430 may initiate a positioning procedure to determine the current location of the UE 510 and store the determined location information.

Thus, in various embodiments, a network node (e.g., the AIoT CN 430) may facilitate the selection of a reader device for positioning an AIoT device that is based on a proximity of the reader device to the AIoT device and/or the capabilities of the reader device with respect to performing AIoT operations associated with the AIoT device and requested by an AIoT server or other entity.

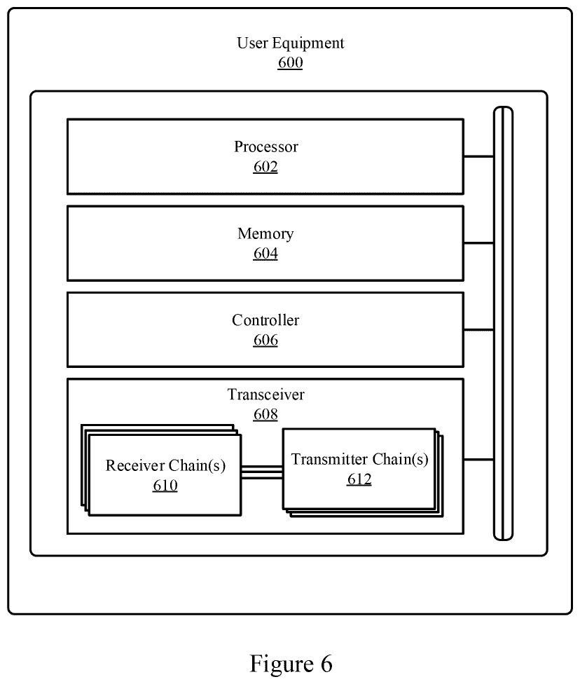

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for transmitting, to an IoT device, a first message that comprises a proximity request, receiving, from the IoT device, a second message that comprises a proximity response, and determining the proximity of the reader device to the IoT device based on the second message.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

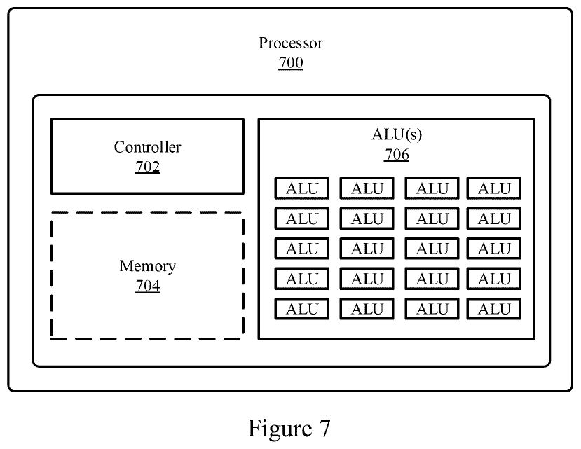

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to support a means for transmitting, to an IoT device, a first message that comprises a proximity request, receiving, from the IoT device, a second message that comprises a proximity response, and determining the proximity of the reader device to the IoT device based on the second message.

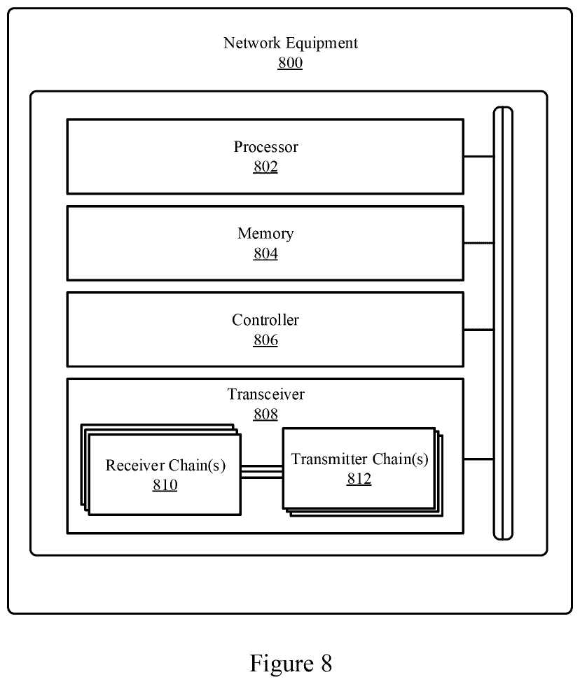

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for transmitting, to an IoT device, a first message that comprises a proximity request, receiving, from the IoT device, a second message that comprises a proximity response, and determining the proximity of the reader device to the IoT device based on the second message.

As another example, the NE 800 may be configured to support a means for transmitting, to a reader device, a first message that comprises one or more criteria for determining a proximity of the reader device to an IoT device, and receiving, from the reader device, a second message that identifies the proximity of the reader device to the IoT device.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

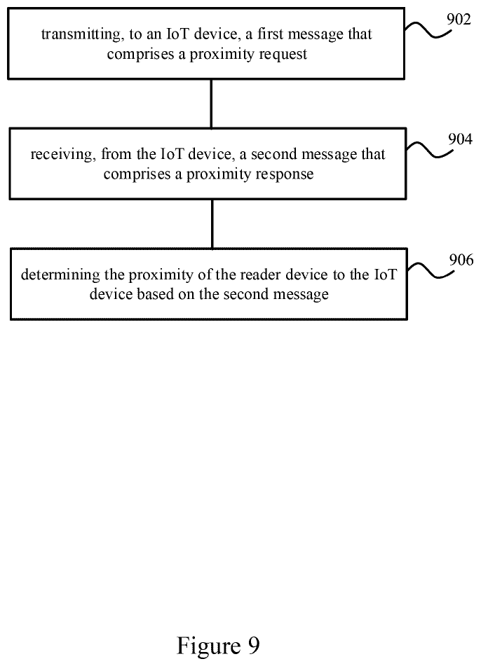

FIG. 9 illustrates a flowchart of a method in accordance with aspects of the present disclosure. The operations of the method may be implemented by a UE or NE as described herein. In some implementations, the UE or NE may execute a set of instructions to control the function elements of the UE or NE to perform the described functions.

At 902, the method may include transmitting, to an IoT device, a first message that comprises a proximity request. The operations of 902 may be performed in accordance with examples as described herein. In some implementations, aspects of the operations of 902 may be performed by a UE as described with reference to FIG. 6 or an NE as described with reference to FIG. 8.

At 904, the method may include receiving, from the IoT device, a second message that comprises a proximity response. The operations of 904 may be performed in accordance with examples as described herein. In some implementations, aspects of the operations of 904 may be performed by a UE as described with reference to FIG. 6 or an NE as described with reference to FIG. 8.

At 906, the method may include determining the proximity of the reader device to the IoT device based on the second message. The operations of 906 may be performed in accordance with examples as described herein. In some implementations, aspects of the operations of 906 may be performed by a UE as described with reference to FIG. 6 or an NE as described with reference to FIG. 8.

It should be noted that the method described herein describes a possible implementation, and that the operations and the steps may be rearranged or otherwise modified and that other implementations are possible.

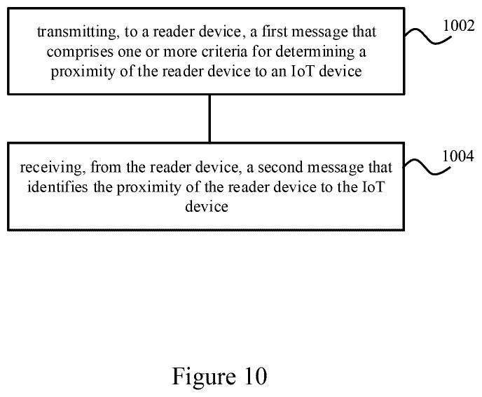

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include transmitting, to a reader device, a first message that comprises one or more criteria for determining a proximity of the reader device to an IoT device. The operations of 1002 may be performed in accordance with examples as described herein. In some implementations, aspects of the operations of 1002 may be performed by an NE as described with reference to FIG. 8.

At 1004, the method may include receiving, from the reader device, a second message that identifies the proximity of the reader device to the IoT device. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A reader device for wireless communication, comprising:
at least one memory; and
at least one processor coupled with the at least one memory and configured to cause the reader device to:
transmit, to an Internet of Things (IoT) device, a first message that comprises a proximity request;
receive, from the IoT device, a second message that comprises a proximity response; and
determine the proximity of the reader device to the IoT device based on the second message.

2. The reader device of claim 1, wherein the at least one processor is further configured to cause the reader device to:
receive a third message from a core network node that comprises one or more criteria to determine the proximity of the reader device to the IoT device; and
transmit a fourth message that indicates the determined proximity to the core network node.

3. The reader device of claim 2, wherein the one or more criteria comprises a distance threshold value between the reader device and the IoT device.

4. The reader device of claim 1, wherein the first message comprises identity information for the IoT device.

5. The reader device of claim 1, wherein, to determine the proximity of the reader device to the IoT device, the at least one processor is further configured to cause the reader device to:
measure a received signal strength indicator (RSSI) associated with the second message; and
determine a distance between the reader device and the IoT device based on the measured RSSI.

6. The reader device of claim 1, wherein the at least one processor is further configured to cause the reader device to determine that the proximity of the reader device satisfies one or more criteria.

7. The reader device of claim 6, wherein the at least one processor is further configured to cause the reader device to:
transmit a message that indicates the determined proximity to a network entity in response to the one or more criteria being satisfied.

8. The reader device of claim 1, wherein the reader device is a user equipment (UE).

9. The reader device of claim 1, wherein the reader device is a network entity.

10. The reader device of claim 1, wherein the IoT device is an ultra-low complexity device with ultra-low power consumption.

11. A core network node for wireless communication, comprising:
at least one memory; and
at least one processor coupled with the at least one memory and configured to cause the core network node to:
transmit, to a reader device, a first message that comprises one or more criteria for determining a proximity of the reader device to an Internet of Things (IoT) device; and
receive, from the reader device, a second message that identifies the proximity of the reader device to the IoT device.

12. The core network node of claim 11, wherein the at least one processor is further configured to:
receive, from an IoT server, a request message that comprises an identifier for the IoT device and the one or more criteria for determining the proximity of the reader device to the IoT device; and
determine a set of candidate reader devices that includes the reader device based on the request message.

13. The core network node of claim 12, wherein the second message comprises an identifier for the reader device and information that indicates a distance between the IoT device and the reader device, and wherein the at least one processor is further configured to cause the core network node to:
select the reader device based on the information that indicates the distance between the IoT device and the reader device; and
store information associated with the selected reader device to a unified data repository that relates the IoT device to reader devices selected for the IoT device.

14. The core network node of claim 11, wherein the at least one processor is further configured to cause the core network node to:
receive, from an IoT server, a request message that comprises positioning service requirements for IoT devices; and
configure a distance threshold value as a criterion of the one or more criteria based on the positioning service requirements.

15. The core network node of claim 11, wherein the at least one processor is further configured to cause the core network node to:
select the reader device to perform a positioning procedure with the IoT device.

16. The core network node of claim 11, wherein the reader device is a user equipment (UE), the at least one processor is further configured to cause the core network node to:
transmit, to a network entity that serves the reader device, a request message that comprises a request for IoT device reader functionality and positioning capability information for the reader device;
receive, from the network entity, a response message that comprises the requested IoT device reader functionality and positioning capability information; and
select the reader device to perform a positioning procedure with the IoT device based on the IoT device reader functionality and positioning capability information.

17. A processor for wireless communication, comprising:
at least one controller coupled with the at least one memory and configured to cause the processor to:
transmit, to an Internet of Things (IoT) device, a first message that comprises a proximity request;
receive, from the IoT device, a second message that comprises a proximity response; and
determine the proximity of the processor to the IoT device based on the second message.

18. The processor of claim 17, wherein the at least one controller is further configured to cause the processor to:
receive a third message from a core network node that comprises one or more criteria to determine the proximity of the processor to the IoT device; and
transmit a fourth message that indicates the determined proximity to the core network node.

19. The processor of claim 17, wherein, to determine the proximity of the reader device to the IoT device, the at least one controller is further configured to cause the processor to:
measure a received signal strength indicator (RSSI) associated with the first message; and
determine a distance between the processor and the IoT device based on the measured RSSI.

20. A method performed by a communication device, the method comprising:
transmitting, to an Internet of Things (IoT) device, a first message that comprises a proximity request;
receiving, from the IoT device, a second message that comprises a proximity response; and
determining the proximity of the communication device to the IoT device based on the second message.
